(19) United States
(12) Patent Application Publication
(10) Pub. No.: US 2002/0059265 A1
(43) Pub. Date: May 16, 2002

(54) Method and apparatus for rendering electronic documents

(76) Inventor: Joseph James Valorose III, Midlothian, VA (US)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 09/828,631

(22) Filed: Apr. 6, 2001

Related U.S. Application Data
(60) Provisional application No. 60/195,621, filed on Apr. 7, 2000.

(51) Int. Cl. G06F 7/00

(52) U.S. Cl. 707/100

(57) ABSTRACT

A computer-implemented method for generating electronic documents, including the steps of: receiving data from at least one application program, dividing the data into text data and graphics data, and generating at least one first file for storing at least a portion of the text data or graphics data, thereby creating an electronic document.

Priority is claimed under 35 U.S.C. § 120 of prior U.S. provisional application serial No. 60/195,621, filed Apr. 7, 2000.

### FIELD OF THE INVENTION

The present invention relates to a method and apparatus for generating and displaying electronic documents, and in particular, a method and apparatus for generating and displaying electronic documents of a new proprietary type termed VPaper.

### DESCRIPTION OF THE RELATED ART

Widespread use of personal computers, modems and data connections has allowed the growth of computer networks. The Internet serves as an example of a type of computer network, and indeed, is a large network of networks, all inter-connected, wherein the processing activity takes place in real time. The Internet offers mail, file transfer, remote log-in and other services. The World Wide Web (WWW) is the fastest growing part of the Internet. On the World Wide Web (WWW), a technology called hypertext allows Internet addressable resources to be connected, or linked, to one another.

Electronic representation of documents, such as contracts, letters, memos and other records has suffered many problems. The most obvious and constraining problem is that the creator of the document in most cases must use an application developed by a third party (e.g., WordPerfect™, Microsoft Word™, etc.) to create and manipulate the document. Thus, the third party application typically becomes the only means of discerning the contents of the document. Although most third party applications include some sort of conversion software (for reading documents created on other platforms), these conversion programs are often not successful in retrieving information.

Even if the third party application includes some type of conversion software, the conversion programs usually handle only aesthetic aspects of the document (such as formatting and layout), and do not reach the author's intellectual reasoning.

If the author's intent is provide the document on a more accessible medium (e.g., paper, on the WWW in Hyper Text Markup Language (HTML), etc.), the author must commit the document to a particular context, which assumes that the intended viewer is an intelligence with reasoning and visual ability. Even assuming this, the content of the document may be taken out of context, thereby leading to misinterpretation.

Although there are applications and technologies which are able to convert documents to other formats, these applications are poor substitutes for a reasoning being. For example, Optical Character Recognition (OCR) systems typically utilize ‘scanning’ technologies to produce an electronic representation of a document. OCR systems are most concerned with determining the shapes and sequences of certain characters (e.g., letters, numbers, etc.). Once rendered, OCR produced documents are often times additionally checked using a spell-checking and thesaurus applications to ensure document integrity. The OCR process is one based in probabilities and therefore a margin of error exists which may create inaccuracies in the rendered document. Although the number of inaccuracies are decreasing due to improvement in the technology, inaccuracies still exist to a great extent.

With current technologies, content and context are inextricably bound together. Above and beyond the actual content of a document (e.g., characters, words, sentences, etc.) is the author's context (i.e., what the author intends the characters to mean). Context is a vital part of the intellectual reasoning used when the author creates the document. Differences in vocabularies and grammar also exist which provide context and affect the formation of content. The reader of the document typically assesses these differences either intuitively, by reference to the subject matter, or by explicit disclosure by the author. None of these determinations can be made by systems such as OCR which operate only on the character level. Intuition and inference requires sentience which computer systems, such as OCR, cannot presently provide.

Computer systems and application programs suffer from the same limitations discussed above in communicating, transporting and extracting content. Object-oriented program modules attempt to either hide content in context (thereby avoiding the above-described dilemma), or publishing and ‘contracting’ its interface, thereby forcing content into context, thus making the application extremely inflexible. Object-oriented program modules define interfaces between themselves and their users. The object-oriented program modules make their interface known to potential users, and ‘contract’ to support these interfaces in future versions even though the internal implementation that carries out the desired action may change. Such change is transparent to the users who still interface with the objected-oriented program module in the same way (i.e., using the same function calls with the same parameters).

The means of communicating between these computer system and application programs is typically a data “payload” scheme, wherein a document's context is in the domain of the sending application. The data “payload” transports content to be processed, stored or evaluated in the target (receiving) system's context.

Therefore, there is currently a need for a system and method for generating and displaying electronic documents which is format, application and system independent and yet preserves the contextual integrity of document content.

### SUMMARY OF THE INVENTION

The present invention is a computer-implemented method for generating electronic documents, including the steps of: receiving data from at least one application program, dividing the data into text data and graphics data, and generating at least one first file for storing at least a portion of the text data or graphics data, thereby creating an electronic document.

The above and other advantages and features of the present invention will be better understood from the following detailed description of the preferred embodiments of the invention which is provided in connection with the accompanying drawings.

### BRIEF DESCRIPTION OF THE DRAWINGS

FIG. 1 is a block diagram showing a system according to an exemplary embodiment of the present invention.

FIG. 2 is a block diagram showing the interaction between an operating system and an program for generating electronic documents.

FIG. 3 is a block diagram and flow chart showing the interaction between an operating system and a program for generating electronic documents.

FIG. 4 is an exemplary computer screen showing a publication information menu.

FIG. 5 is an exemplary computer screen showing a page layout menu.

FIG. 6 is an exemplary computer screen showing a graphics menu.

FIG. 7 is an exemplary computer screen showing a security menu.

### DETAILED DESCRIPTION

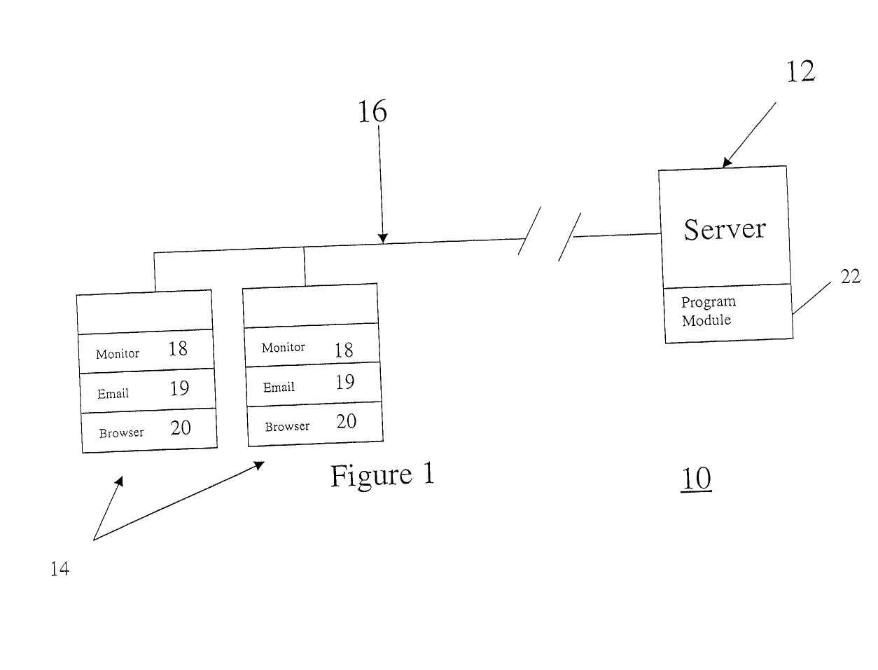

Referring to FIG. 1, there is shown a system 10 according to an exemplary embodiment of the present invention. The system 10 includes a server computer 12 and a plurality of users' computers 14 (clients). The server computer 12 and the user computers 14 may be connected by a network 16, such as for example, an Intranet or the Internet. The user computers 14 may be connected to the Intranet or Internet by a modem connection, a Local Area Network (LAN), cable modem, digital subscriber line (DSL), or other equivalent connection means. Each user computer 14 preferably includes a video monitor 18 for displaying information. Additionally, each user computer 14 preferably includes an electronic mail (e-mail) program 19 (e.g., Microsoft Outlook™) and a browser program 20 (e.g. Microsoft Internet Explorer™, Netscape Navigator™, etc.), as is well known in the art. The server computer 12 includes a program module 22 (explained in detail below) which operates to send emails to the user computers and provide tracking functions. The program module 22 includes program code, preferably written in PERL, Extensible Markup Language (XML), Java and/or Hypertext Mark-up Language (HTML), which operates in conjunction with the user computers 14 to generate and display electronic documents.

The prevent invention is a method and apparatus for rendering electronic documents. The present inventor [inventors?] has developed a new type of electronic document format (referred to herein as “VPaper”) which is conceptually similar to conventional document formats such as “.doc” (Microsoft Word™), “.wpd” (WordPerfect™), ” and “.pdf” (Adobe Acrobat™) and others. VPaper has many unique characteristics, however, which differentiate it from conventional document formats. One of the most interesting characteristics of VPaper is that it is based on public domain standards and protocols. Unlike proprietary document formats (e.g., “.wpd” (WordPerfect™ document type)) which require the originating party (i.e., the creator of the proprietary document format, in the case of WordPerfect™, Corel would be the originating party) to provide a means of creating, storing, parsing, formatting, presenting, logically processing, and embedding context (typically through an application program such as WordPerfect™), VPaper is based on public domain standards and protocols for its internal representation, structure, and transportation. Use of these public domain standards and protocols allows any application program or computer system which uses the same protocols to process content and context of the document (i.e., the document rendered in VPaper is not application sensitive).

Because of the above, VPaper documents retain their coherency and context at a very granular level. The granularity may be specified during the creation of the document, or specified during subsequent processing. Using standard vocabularies and grammar, the granularity can be as small as an individual word element (e.g., character) or as large as the entire document. Vocabularies and grammar may link, recur, exclude, include, or be created from and by other vocabularies and grammars, and applied locally at the elemental level, in context of the elements or globally in the document. This provides a means of capturing and disseminating information into human form, whose attributes typically contain multiple domains, or computer-to-computer communications, which are typically a single domain. In other words, humans often use multiple understanding contexts within a single document, and the flexibleness of the granularity definitions allows for just such multiple contexts within the same document.

The VPaper document also contains and transports a map of itself with the document it is contained within. In other words, VPaper will contain not only the content, but all the contextual definitions as well. Thus, the receiver of a VPaper document does not need to have prior knowledge of the contextual definitions since the VPaper document will be self-defining in this way. This allows the receiver to accept all VPaper documents, not just ones that follow its pre-defined set of contextual definitions. Due to the granularity, information about the an element of the document (e.g., word, sentence, paragraph, etc.) may be included with the element. This provides the content (i.e., the words) with context (i.e., in the form of vocabulary and grammar).

As will be understood, VPaper presents certain unique aspects. For example, take a VPaper document which is a letter (which includes both content and context). Using the system of the present invention, queries may be created which ‘ask’ the VPaper document to produce certain elements thereof, such as: “Whom is the letter addressed to?”, “Where does the addressee live?”, “What is the subject of the letter?”, or “Is the letter business or personal?” The contextual definitions included in the VPaper document define the context for interpreting content, such as a block of text. As an example, consider a contextual definition that states that the first block of text that starts on the left margin is the address of the addressee. The VPaper document receiver uses the contextual definitions included in the document to understand what the various components of the content are. The finer the granularity of the contextual definition, the more detailed an “understanding of the document the receiver will have.

The characteristics mentioned above lend themselves easily to several markup languages (e.g., HTML), including the World Wide Web Consortium's (W3C) Extensible Markup Language (XML). XML utilizes the ASCII character set internally to represent the document content as well as to provide a description of the document, including document type description (DTD), or document object model (DOM), and granularity at the element (e.g., character, word, etc.) level. VPaper encodes and stores context with these elements in the form of “metadata”, as will be understood by those skilled in the art. The stored content can be later retrieved, such as through the W3C's Extensible Query Language (XQL).

VPaper also provides security for documents. An author may secure elements (e.g., characters, words, etc.) of the document either by encryption, hash (explained below), or by digital signature. Well-known in the art, a (one-way) hash is a mathematical algorithm used to generate a fixed-length string of digits from a variable length input string. By its nature a one-way hash does not allow the reconstruction of the input from the hash. Typically used in encryption and data integrity operations, it is closely related to the digital signature. The security granularity may be at the elemental level (e.g., validate that a sentence has not been altered), or to an aggregate of elements (e.g., encryption of a clause which permits changes only by authorized parties identified in the document, wherein authorized parties must digitally initial changes to content and context). Security methods may be as simple as symmetrical key or password, or as complex as a public key infrastructure (PKI) complete with X.509 certificates and issuing authorities. As is well known in the art, PKI is a system of digital certificates, certificate authorities, and other registration authorities that verify and authenticate the validity of each party involved in an Internet transaction. PKIs are currently evolving and there is no single PKI or even a single agreed-upon standard for setting up a PKI. However, X.509 is the most widely used standard for defining digital certificates. The Internet Engineering Task Force's (IETF) Base-64 MIME encoding standard is well suited as a means of representing VPaper security elements such as message digests and message hashes, and would ensure interoperability and non-binary representation of elements.

As stated above the VPaper document may be queried by various methods known in the art. Thus, the document may be ‘asked’ to present content in context, to disclose its domain, to produce information about its content (“metadatal” referred to above), to verify the integrity of the author's writings, and secure and/or encrypt all or portions thereof. This presents other opportunities in which the author may control the dissemination, usage and alteration of the content. For example, the author may decline any usage of his work in any other manner than what he has pre-approved. In such a case, the author could encrypt the entire document, or prevent authentication of his content for use elsewhere.

The advantages of VPaper are best described with reference to a specific example. For instance, consider an individual preparing their tax return. Assuming all documents are in VPaper format, the individual would require a W-2 form from their employer, possibly a 1099 form from their banker, and a portfolio statement from their investment institution. The individual would then extract information elements from the W-2, the 1099, and the portfolio statement (e.g., by ‘cutting’ the elements from the different documents using a clipboard editor). The individual could then electronically insert this information into a 1040 form (also in VPaper format) (e.g., by ‘pasting’ the elements into the 1040). The above-referenced elements may be ‘cut’ and ‘pasted’ using an electronic clipboard editor operating, for example, in XQL. The individual could then electronically ‘sign’ the return and forward it to the Internal Revenue Service (IRS). Alternatively, the individual could provide security measures for the document (1040) such as authorizing only the IRS to view the document, or only allowing the individual's accountant to make revisions to the document. The IRS can verify the return is the individual's by the digital signature. If the individual's accountant were to make revisions to the application, the accountant would forward the document back to the individual for re-validation before forwarding the return to the IRS. The IRS, in turn, could then validate that the individual certified the return, identify and authenticate the accountant's changes, and compare the original to the amended return to quickly spot the amendments.

Because of the above-described properties of VPaper documents, additional processing can be authenticated and/or authorized in the document itself without revocation of the content. The VPaper document defines what parts of the document may be modified or even copied without violating the contextual integrity of the document or its elemental parts. If a manipulation of the document is requested that is not within the security rules defined by the document (e.g., the requester does not know the password to change a protected field), the manipulation must either be disallowed or the document must no longer carry forward the original security credentials and authentications. Transformation, linking and extraction of data among VPaper documents may be accomplished through the W3C's extensible style sheet language for transformation (XSLT).

Another benefit of present invention is that VPaper documents can be easily rendered in various mediums. VPaper documents may be both viewed and printed. While most application programs are concerned with representing a document as it would appear on a piece of paper, the VPaper document system is concerned with content. Thus, VPaper may be viewed either by the application which created it (e.g., WordPerfect™, Microsoft Word™), or by a browser program (e.g., Netscape Navigator™, Microsoft Explorer™).

The W3C's Extensible Stylesheet Language (XSL) and Cascading Style Sheets (CSS) may be implemented to handle layout and format of the contents of the VPaper document. Because, as explained above, the content may be secured, and its validity ensured, the Extensible Stylesheet Language for Transformation (XSLT) may be used to move different elements of the VPaper document around, without violating the content or context. Provisions for XSL and XSLT allow different output mediums (e.g., word processing programs, browser programs, printers, etc.) to be used.

Additionally, since the structure and contents of VPaper documents are represented in ASCII the documents are easily legible by a human viewer. The VPaper document (content and context) may therefore be interpreted without a program application or computer assistance. These characteristics lend themselves easily to markup languages such as HTML or XML.

Another benefit of the present invention is that VPaper documents may be easily interpreted by various types of peripheral computing devices (e.g., printers). The format, content, and binary data of the VPaper document may be presented to peripheral devices in its native form, without the need for transformation. An embedded process that would take as its input a VPaper document and produce a printed piece of paper would embody a Print-capable Extensible Markup Language (P-XML). Similar to the way languages such as PostScript (PS) and Page Control Language (PCL) convert word processor files (e.g., “.wpd”) to files which are printable using a printer, P-XML would take XML files and directly print them.

Yet another benefit of the present invention is that VPaper documents may be created from non-VPaper enabled application programs (e.g., WordPerfect™) and computer systems. One means for accomplishing this is through the “print” function of these application programs.

The richness of many modem graphical user interfaces relies on the ability to interpret ASCII input and form a graphical representation of the character system. The input ASCII character stream is then passed to an operating system (e.g., Microsoft Windows™) for further processing (parsing, formatting, etc.) before being transmitted to a peripheral, such as a printer. The means by which an operating system communicates with a printer is through a print driver.

The present invention utilizes a novel method and apparatus for operating system/printer communications which is referred to herein as “XScribe.” XScribe is a program which works with the operating system (e.g., Microsoft Windows™) to accept print requests and subsequent graphical and textual data from application programs (e.g., WordPerfect™). However, instead of communicating with a peripheral device (e.g., printer), XScribe processes documents in VPaper format. In other words, instead of sending a print stream from the application program to the printer through the operating system, the print stream is sent from the application to a specified destination location (e.g., file in computer memory, website location, etc.) where VPaper is created. Control of the content and context of the application program's output is via a template-based parser that can understand the application program's print content and provide context as well as layout and format, with a high degree of fidelity to the author's intentions.

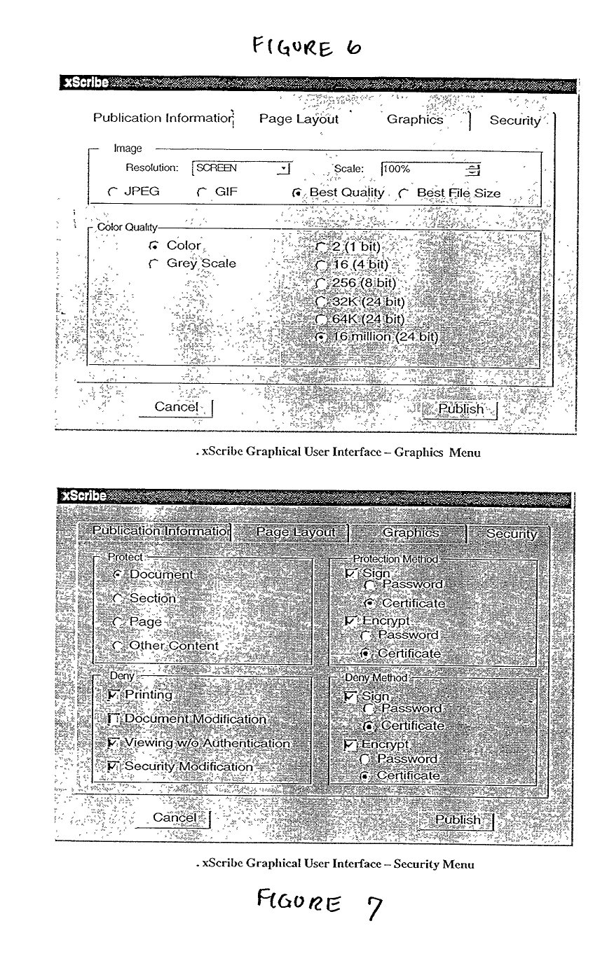

In the process according to the present invention, a graphical user interface (GUI) is presented to the author or end-user of the application in which the end-user may set and/or change the parameters of the VPaper document (see FIGS. 6-9, described below). This would include a default layout, the security and validity settings, the resolution of graphical information in the document, as well as the destination of the document (e.g., computer system, website, P-XML device).

When a call for generation of a VPaper document is made, such as by selecting the printer icon on an application's tool bar, control is passed to the XScribe program which communicates asynchronously with the application program and the operating system (either directly or through a storage medium such as a hard drive or print spooler).

XScribe assesses the content of the application print stream as it is presented by the application program (e.g., WordPerfect™). The assessment takes into account layout and position of the elements of the document (e.g., WordPerfect™ document) within the application program's context, and stores the information. Content is then assessed to determine whether it is text or graphics. If graphics, XScribe renders it according the author's or end-user's preferences and stores it with the VPaper document. If text, any glyph or font information is separated from the character stream, resulting a format information stream and a pure text stream. The format information is stored in the same manner as the graphical information, and the pure text stream is evaluated by the template-based parser for context information. The resulting text stream along with its associated metadata (information about the context), vocabulary and grammar information are then stored in the VPaper document.

The application program (e.g., WordPerfect™) looks upon XScribe as just another printer. As such, when the end-user wishes to set the printer options, the application program will notify XScribe to display its own customized printer options dialog box. FIGS. 4-7 show different menu screens of an XScribe printer options dialog box.

One of the items on a publication information menu screen (FIG. 4) of the printer options dialog box may be used to specify the type of document or “Template Type” (e.g., ACME Insurance Form 509-a). It will be noted that this “Template Type” is not a document format, but a document context. A company may have, for example, a hundred different form letters stored as WordPerfect™ documents. This would represent 100 different document types because there are 100 different contexts. By the selection of the document type, XScribe knows which pre-defined context definition (i.e., template) to use. This context definition is the source of the vocabulary and grammar information previously referenced.

As discussed above, the XScribe program is used to create VPaper. The XScribe program may be deployed on any computer system, or within any software application using a print driver model. This includes, local, peer-to-peer, clientlserver, remotely via private network or Internet-based.

Being modeled after a print driver in most computer operating systems, the XScribe program is unobtrusive to the end-user until needed. When an end-user wishes to create a VPaper-based document, they will select to “print” (using a button icon on a toolbar of the application, or otherwise) from the application they are using (e.g., WordPerfect™), as they would if they were printing any other document (e.g., “.wpd” file).

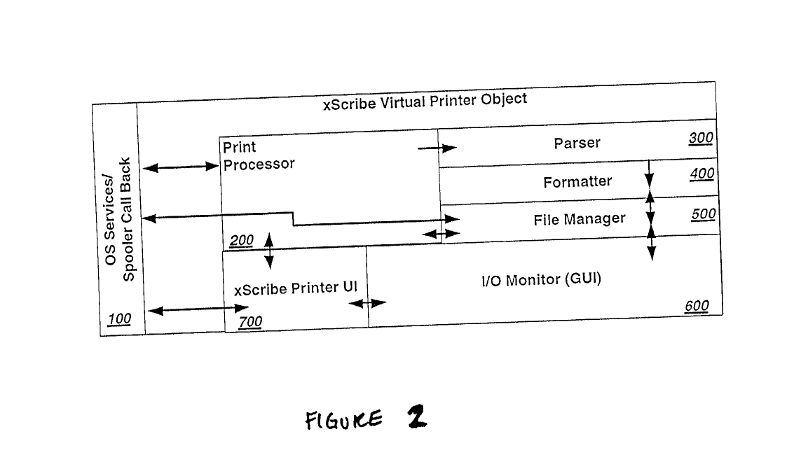

FIG. 2 is a block diagram showing the interaction between an operating system (e.g., Microsoft Windows™) and the XScribe program. At the point when a document is selected for transformation to VPaper, the operating system initializes the XScribe print driver, and executes the XScribe Printer User Interface (UI) configuration module 700. The XScribe UI presents the end-user with a means of configuring the requested VPaper print job. By manipulating the elements of the XScribe UI, the end-user may change the parameters, features and/or destination of the resulting VPaper document.

After ensuring the location and supporting parameters have been confirmed and the spooler (if provided) are available, control is then passed back to the operating system or application, which then executes it print functions as normal.

During printing (i.e., the creation of VPaper), a display panel displayed on the video monitor 18 of the user computer 14 will provide the end-user feedback regarding progress for the process, and give the end-user the option to cancel printing. The management of the display panel is accomplished through an Input/Output (I/O) Monitor Graphical User Interface (GUI) 600.

Periodically, as the spooler, operating system or application, makes its requests of XScribe to render the printed output, a print processor 200 will receive the requested information and move it to a parser 300. The parser 300 will assess the content of the print request and pass this information to the formatter 400 for rendering, storage and layout. Since the content and context of a document must be known, a template-based approach, herein called “DScribe”, will be used to provide the details. The DScribe template may be stored locally within the context of the enduser's environment, or established remotely, via the Internet or private network. Once the content and context has been established, formatted and rendered (if graphical), the formatter 300 will pass this information to the file manager 500. The file manager 500 ensures that the packages of content (graphics, test, fonts, format and layout) are accumulated and delivered to their final destination, as configured in the XScribe UI 700. The I/O Monitor GUI 600 will communicate with the end-user's environment and the file manager 500 to ensure delivery, and to ensure that session level communications are kept active.

The entire process is asynchronous from the end-user's perspective, therefore the I/O Monitor GUI 600 must also monitor if the print job has been canceled by the end-user. If so, the I/O Monitor GUI 600 will pass control back to the file manager 500 to manage any necessary clean up and/or maintenance associated with stopping without completion. And finally, the print processor 200 finishes up and completes the process.

For purposes of the following, an operating system should be taken to mean any software or hardware operating system, platform, application, technical infrastructure or network that supports, executes or is a third party software application (e.g., Microsoft Windows™, LINUX).

When a program is run on a computer platform, one of the most prevalent methods for creating output is the “print” command. When an end-user selects to “print” a document, the application (e.g., WordPerfect™) will call the operating system's print functionality, which will usually then initialize the printing process. During initialization of the printing process by the operating system, the end-user is presented with print options provided by the operating system which can include the printer name, printer options, number of copies, and other generalized functions.

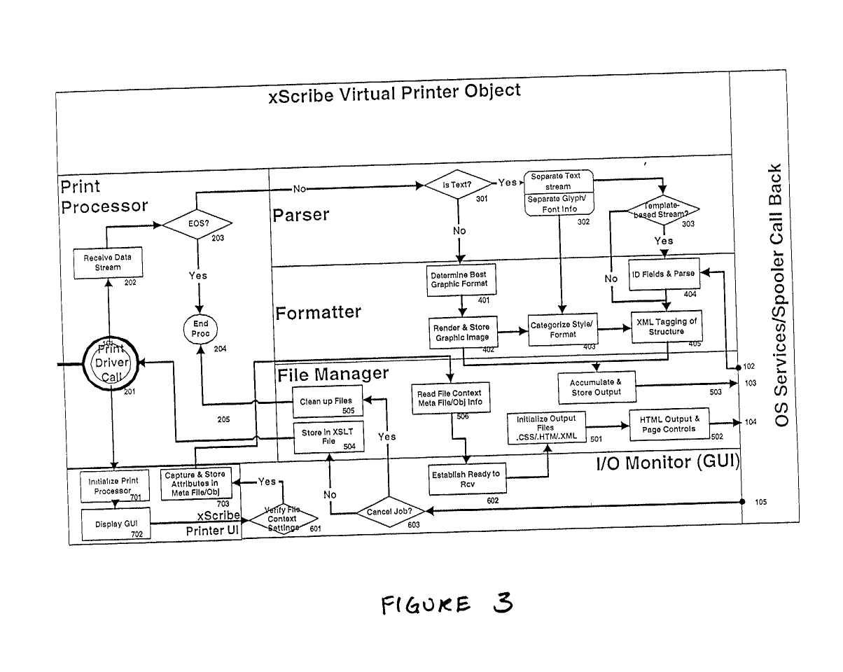

FIG. 3 is a block diagram showing the process of FIG. 2 in more detail. Initialization of the printing process includes starting the spooler service (if provided and not already started), and allows the end-users to select the printer they wish to send the print job to by a print driver call at step 101 (i.e., application requests printer function from operating system). Because the boundary of operating system and print driver is blurred by most platforms, a print driver call step 201 (i.e., operating system conveys application request to the XScribe print processor) is also part of the XScribe print processor. Thus, what would typically be considered a 1-step process becomes a 2-step process in most instances because in most systems the application (e.g., WordPerfect™) has to communicate to the printer processor by way of the operating system (e.g., Microsoft Windows™). For XScribe, the end-user selects the XScribe printer, previously installed, which then initializes the print processor at step 701.

If the end-user wants to configure the XScribe printer properties, control is then passed to the XScribe GUI at step 702, where the end-user may change the characteristics of the XScribe process.

FIGS. 4-7 show the details of the XScribe Printer GUI. The XScribe Printer GUI is the main menu the end-user is presented with when configuring a VPaper document. Most of the print job configuration occurs on this menu, and options for publication information, page layout, graphics and security are set. On the bottom of this main menu, the end-user may, at any time, cancel (See FIGS. 4-7) configuration (by selecting the “Cancel” button on the menu), in which case they are taken back to the operating system Print Menu. Alternatively, the end-user may select the “Publish” button (FIGS. 4-7) to accept the current setting, and start the XScribe print process.

FIG. 4 shows a publication information menu. Since the VPaper document may be several documents, a publication name, may be set by the end-user. The publication information menu provides the end-user several other options. Once the publication is named, the end-user will have several options for its destination. A local directory location will provide traditional file management that will include graphical browsing and storage. The P-XML location would be to any device that understands VPaper, with a minimum of XML as a requirement and is directly attached to the end-user's environment. The HTTP/Web Site location allows the end-user to specify a website location (e.g., Uniform Resource Locator (URL) or Internet Protocol (IP) address) for publication. The end-user may also specify login information for the website via the “Login Info” button. The Simple Object Access Protocol (SOAP) and rudimentary HTTP GET and PUT statements are two existing methods that may be employed to communicate with the website. The end-user may also opt to e-mail the VPaper to a specific e-mail address (e.g., “mailbox@mailserver.com”). Finally, the end-user may elect to utilize File Transfer Protocol (FTP) to publish a VPaper document to a remote location. As with the website option, the FTP option also allows the end-user to select login information for security purposes (via “Login Info” button).

The publication information menu also allows the end-user to select a template type. The template type pull-down menu includes a list of DScribe templates the end-user may select to process their document. This list may be stored locally (on the end-user's hard drive), or remotely (on a remote server accessed through the Internet or an Intranet).

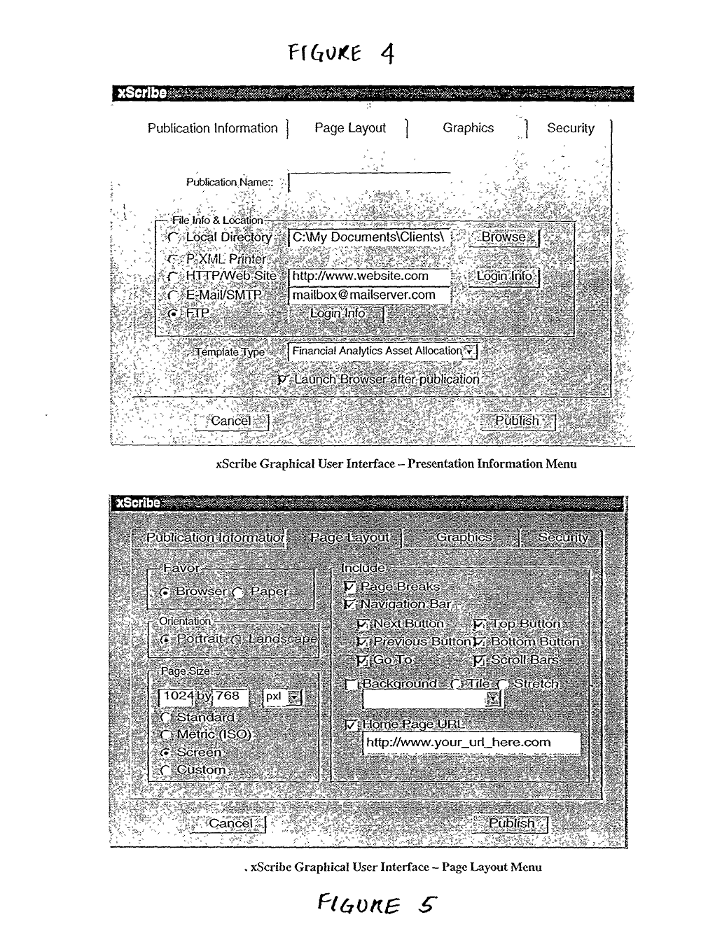

FIG. 5 shows a page layout menu. The page layout menu allows the end-user to change the page layout associated with the VPaper. Since VPaper is not primarily concerned with exact rendering of a document, the end-user may wish to favor certain page layouts. To that end, the end-user may select to “favor” a browser type layout or a paper type layout (using the “Favor” sub-menu). Since a browser type documents have no pre-defined dimensions, the end-user may choose to have the VPaper rendered as a single document (by selecting, for example, a “page size” of the entire computer screen). Further, when selecting a browser type layout, the end-user also has the option of including toolbar functions (e.g., “next button”, “scroll bars”, etc.) with the browser window (by selecting the appropriate options in the “Include” sub-menu). Although most of the function in the “Include” sub-menu are self-explanatory, it should be noted that the “Go To” option allows a viewer to jump to a specific page of the document. It should also be noted that the “Include” sub-menu is only available if “Browser” is selected in the “Favor” sub-menu. Paper type documents, alternatively, have specific dimensions (e.g., Standard, A4, Legal, etc), and therefore selecting a “page size” is not really an issue. The end-user is also given the option of selecting an orientation for the resulting document by selecting the 25 appropriate option (e.g., “Portrait” or “Landscape”) from the “Orientation” sub-menu.

Because VPaper is an electronic representation of a document, the end-user may also wish to provide additional features to the VPaper output including a background image that may represent a watermark or aesthetic enhancement (by selecting the “Background” option from the “Include” sub-menu and specifying a drive location for the background). The background may arranged in “Tile” format, where the image is repeated in its original dimensions across and down the document dimensions, or “Stretch” format, where the image may be expanded or contracted to fill the document dimensions.

FIG. 6 shows a graphics menu. The graphics menu allows the end-user to change images and image quality. As XScribe encounters a graphical image (see FIG. 3, step 301), evaluation of the image will use these settings as guidelines. The end-user has several options on Image Resolution (selected by the “Resolution” pull-down menu). The resolution choices include the current screen settings (“SCREEN”), a P-XML enabled printer and its resolution (“P-XML”), the original resolution of the image from the third party application (“ORIGINAL”), LOW (e.g. 32 dot per inch), MEDIUM (e.g. 72 dot per inch), CRISP (e.g. 96 dots per inch) and HIGH (e.g. 144 dots per inch) depending on the operating system's capabilities. The end-user may also select to scale the rendered images as a percentage of the original document size (using the “Scale” pull-down menu). Additionally, the end-user may chose to default all images to certain type (e.g, JPEG, GIF, TIFF, etc.), depending on their needs. Selection of the “Best Quality” button will indicate to the XScribe print processor to choose a format that delivers the most exact reproduction of the original image. Selection of the “Best File Size” button will indicate to the XScribe print processor to choose a format that reduces transmission time.

When XScribe is installed, it will register itself with the operating system as a color printer driver, and therefore color quality may also be controlled by the end-user (through the “Color Quality” sub-menu). If a non-color P-XML printer, or some other non-color device, is selected from the presentation information menu (See FIG. 4), “Grey Scale” will be the default setting, otherwise the default is “Color.” The “Color Quality” density, as measured in bits, may also be selected by the end-user, which will affect the file size and exactness of the reproduced image to the original.

FIG. 7 shows a security menu. The security menu allows the end-user to adjust the security settings of the resulting VPaper. It should be noted that if there is a DScribe template associated with the VPaper print job, it will take precedence over these settings. However, the end-user may further restrict the security settings over the resulting VPaper. This is important, as some applications will claim as intellectual capital its reports, but it cannot claim the same right to end-user input information.

The end-user may select to further protect the VPaper document, or portions thereof (e.g., section, page, etc.) via various protection methods. First, the end-user selects what to protect in the “Protect” sub-menu. Then, the end-user selects a protection method in the “Protection Method” sub-menu. The end-user may also choose to deny access to certain functions, which may be chosen using the “Deny” sub-menu. Again, the end-user must select a method for accomplishing the denial, using the “Deny Method” sub-menu.

The protection methods and deny methods are used to digitally ‘sign’ the protected/denied selection either via an asymmetrical key, such as a password, or with a digital certificate provided from any certificate authority using the Public Key Infrastructure (PKI). These methods provide authentication, authorization and non-repudiation.

Referring again to FIG. 3, when the end-user selects to Publish a VPaper document, the XScribe UI 700, transfers control to the I/O Monitor 600 where the end-user settings are validated and verified (step 601). These settings are then initialized into the XScribe print driver, and stored as general settings (step 703), so that the end-user's preferences can be reused when the XScribe print driver is used again.

Because this is part of the initialization, control is then passed to File Manager 500, where the end-user's settings are read and evaluated (step 506). Based on the settings for location of the published document (See FIG. 4), control is passed to the I/O Monitor 600, and the location is verified, communications are established, and the location is primed to receive VPaper output (step 602). The print processor 200 then transfers control to the File Manager 500 where the destination files (e.g., CSS, HTM, XML) are opened and initialized (step 501). Again, based on the end-user's settings, options for page layout are written to the destination location with the aid of the operating system (step 104). Processing is then continued by passing control to the Print Driver Interface (step 201).

As the print stream from the selected application (e.g., WordPerfect™) arrives at the XScribe print processor 200 from the operating system, the stream is received, stored in local buffers and validated for content (step 202). At this point, the destination (e.g., local buffers) will have all of the parts of the VPaper document that are driven by the printer options (including the selection of the document type, thus defining the context of the document), namely: (a) options for page layout/controls stored in XSL and/or CSSIHTM format, (b) meta-data defining the context of the document stored in XML format, (c) security information stored in XML format, and (d) document transformation rules stored in XSLT format.

Since the print streams will arrive asynchronously from the operating system, a timer is set (step 105) to poll and monitor activity on the newly created interface channel (step 101). This timer will periodically check the status of the channel and, if there is activity from the operating system, will reset itself. If no activity has occurred during the timer function, an End-Of-Stream (EOS) condition will be set (step 203). If the operating system indicates the end of the print job, EOS will also be set. If no EOS is indicated, then a valid print stream is assumed and processing continues (to step 301).

Process control continues to where the EOS condition is evaluated (step 203). If it is indeed an EOS condition, the XScribe print processor 200 executes an “End Processing (End Proc)” function (step 204) which commits or flushes its buffers (i.e., the information stored in the temporary memory buffers used in the XScribe process is deleted), closes all opened files, flushes the print spooler, passes control to the operating system and removes itself from memory. If, however, the EOS condition does not exist, the print stream is then passed to the Parser 300.

When the print stream is passed to the Parser 300, the print stream content (preferably stored in a local buffer) is evaluated (step 301). If the content is an image or cannot be determined, then the contents of the buffer will be assumed to be graphical. Based on the end-user's preferences and settings for graphic information, (See FIG. 8), the XScribe print processor 200 determines the “best format” for the image (step 401). A call is then made to the appropriate graphics library to render and create the image document in the chosen format (step 402).

If, however, the content is textual information, then the print stream will be parsed to separate a glyph or font formatting of the print stream from text content (step 302). A separate processing thread is spawned to further process the text information (at step 303, explained below).

The glyph/font, relative offset, style, character code and any other format information for either text or image are then categorized (step 403). Information is then categorized by font type, print areas, dimensions, text wrapping and/or overlays, etc. depending on the supporting operating system and placed in an internal structure and buffer for easy markup.

The spawned thread for text-based processing, based on the end-user's settings and preferences, will then determine if the text is to be processed via a DScribe template (step 303). If there is no template information associated with the print job, a default DScribe template will be used, which will enumerate individual elements of the text. However, if a valid DScribe template is associated with the print job, the DScribe template is loaded into the print processor 200 (step 102). The text is then parsed for key textual items associated with the DScribe template, context added and stored within the internal structure and meta-information will be provided via the DScribe template for the associated fields, data, sentences and the structure will be bound to its context (step 404).

All accumulated structures and buffers are then brought together for conversion to VPaper (step 405). At this point, the buffers will contain all of the parts of the VPaper document that are driven by the original document's content, namely: (a) text tagged and stored in XML format, (b) glyph and font information stored in XSL format, and (c) graphics stored in the selected format (e.g., JPEG, GIF, TIFF, etc.).

The individual, discrete components are tagged, formatted, organized and associated with all supporting file references (such as image), structures, formats and layouts (step 405) and written to another internal buffer (step 503) or pseudospooler. Due to the asynchronous, multi-threaded processing and communications to possibly remote network devices, it is necessary to ensure good communication channels and organization, allow for process synchronization and also provide spooler support and compatibility, depending on the level of operating system support.

The pseudo-spooler will transmit its data to the destination (e.g., local file, web site or whatever location was selected on the printer options dialog box) when it gets full (step 103). The pseudo-spooler will also ensure that its data has been properly received by the destination. Once receipt of the transmission has completed, as indicated by the I/O Monitor 600 (step 106), any layout and dynamic control of the VPaper document is stored in a rendering file format (step 504).

The process continues until the operating system indicates an EOS condition (detected at step 203) or the end-user cancels the print job (detected at step 603). Accordingly, the I/O Monitor 600 must also perform this monitoring function.

If the end-user chooses to cancel the print job, or the process has timed out because the timer has elapsed, the print processor is notified by the operating system during its polling cycle (step 105).

If canceled, the XScribe print processor 200 will remove any files it has written, set the EOS condition to “TRUE” and perform the “End Proc” functions (step 204).

It should be noted that the present invention may be embodied in the form of computer-implemented processes and apparatus for practicing those processes. The present invention may also be embodied in the form of computer program code embodied in tangible media, such as floppy diskettes, read only memories (ROMs), CD-ROMS, hard drives, high density disk, or any other computer-readable storage medium, wherein, when the computer program code is loaded into and executed by a computer, the computer becomes an apparatus for practicing the invention.

The present invention may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general purpose processor, the computer program code segments configure the processor to create specific logic circuits.

Although the invention has been described in terms of exemplary embodiments, it is not limited thereto. Rather, the appended claims should be construed broadly, to include other variants and embodiments of the invention which may be made by those skilled in the art without departing from the scope and range of equivalents of the invention.

What is claimed is:

1. A computer-implemented method for generating electronic documents, comprising the steps of:
receiving data from at least one application program;
dividing the data into text data and graphics data;
generating at least one first file for storing at least a portion of the text data or graphics data.

2. The computer-implemented method of claim 1, wherein the step of dividing the data into text data and graphics data further comprises:
separating a text portion of the text data from a glyph portion of the text data.

3. The computer-implemented method of claim 1, wherein the step of generating at least one first file comprises generating at least three files.

4. The computer-implemented method of claim 3, wherein at least one of the at least three files comprises an XML file.

5. The computer-implemented method of claim 1, comprising the further step of:
permitting a user to specify at least one property of the at least one first file before the at least one first file is generated.

6. The computer-implemented method of claim 5, wherein said at least one property comprises a location for the at least one file.

7. The computer-implemented method of claim 5, wherein said at least one property comprises security information for the at least one file.

8. The computer-implemented method of claim 5, wherein said at least one property comprises a template type for the at least one file.

9. The computer-implemented method of claim 1, wherein the step of dividing the data comprises:
transmitting the data to a parser to determine if the data is text data or graphics data; and,
transmitting the data to a formatter to determine the optimal format for the data.

10. The computer-implemented method of claim 1, comprising the further step of:
transmitting the data to a file manager after the data is divided but before said at least one first file is generated.

11. The computer-implemented method of claim 1, wherein the at least one application program comprises a word processing program.

12. The computer-implemented method of claim 1, wherein the at least one file comprises:
a text portion in XML format, if the data received from the at least one application program includes text data; and,
a graphics portion, if the data received from the at least one application program includes graphics data.

13. The computer-implemented method of claim 12, wherein the at least one file further comprises:
a glyph and font portion in XSL format, if the data received from the at least one application program includes text data.

14. The computer-implemented method of claim 1, wherein the at least one file has a first file format which is different from a file format of the file format of the at least one application program.

15. A computer system comprising:
at least one server; and,
at least one user computer coupled to the at least one server through a network,
wherein the at least one server computer includes at least one program stored therein, said program performing the following steps:
receiving data from at least one application program;
dividing the data into text data and graphics data; and,
generating at least one first file for storing at least a portion of the text data and graphics data.

16. A computer system comprising:
at least one server computer; and, at least one user computer coupled to the at least one server computer through a network;
wherein the at least one server computer and the at least one user computer each include at least one program stored therein for allowing the at least one server computer and the at least one user computer to communicate information over the network, said programs operating in conjunction with one another to perform the following steps:
receiving data from at least one application program;
dividing the data into text data and graphics data; and,
generating at least one first file for storing at least a portion of the text data and graphics data.

17. A computer readable medium having embodied thereon a computer program for processing by a machine, the computer program comprising:
a first code segment for receiving data from at least one application program;
a second code segment for dividing the data into text data and graphics data; and,
a third code segment for generating at least one first file for storing at least a portion of the text data and graphics data.

18. A computer data signal embodied in a carrier wave comprising:
a first code segment for receiving data from at least one application program;
a second code segment for dividing the data into text data and graphics data; and,
a third code segment for generating at least one first file for storing at least a portion of the text data and graphics data.

19. A computer system comprising:
an operating system operating on at least one computer;
an application program operating on said at least one computer;
an additional program for handling print requests from the application program using the operating system, said additional program manipulating at least one data stream generated by the application program to create a format independent document.

20. The computer system of claim 19, wherein the additional program includes:
a parser component for separating text data from graphics data;
a formatter component for formatting the text data or graphics data; and,
a file manager component for ensuring that the format independent document is created in a specified location.
